(19) United States
(12) Patent Application Publication
(10) Pub. No.: US 2014/0029912 A1
(43) Pub. Date: Jan. 30, 2014

(54) DISPLAY CONTROL APPARATUS AND DISPLAY CONTROL METHOD

(71) Applicant: CANON KABUSHIKI KAISHA, Tokyo (JP)

(72) Inventor: Yousuke Takagi, Yokohama-shi (JP)

(21) Appl. No.: 13/949,740

(22) Filed: Jul. 24, 2013

(30) Foreign Application Priority Data
Jul. 26, 2012 (JP) 2012-166339

(51) Int. Cl. H04N 9/87

(52) U.S. Cl. CPC H04N 9/87
USPC 386/225; 386/230

(57) ABSTRACT

A display control apparatus comprises a recording unit which records a still image and a moving image associated with the still image on a recording medium; a setting unit which sets whether to set the associated moving image as a start image to be displayed first at a start of image reproduction; and a control unit which controls to, when the associated moving image has been set as the start image, display the associated moving image from images recorded on the recording medium at the start of image reproduction, and controls to, when the associated moving image has not been set as the start image, display an image based on another condition irrelevant to whether the image is the associated moving image, from images recorded on the recording medium at the start of image reproduction.

### BACKGROUND OF THE INVENTION

1. Field of the Invention

The present invention relates to an image display control apparatus and display control method.

2. Description of the Related Art

Recently, a function of shooting a still image during moving image shooting, and a function of automatically recording a moving image immediately before shooting at the same time as still image shooting have been proposed as shooting functions of digital cameras.

Japanese Patent Laid-Open No. 2000-222417 discloses a technique of, when a moving image associated with a still image which is being viewed exists in a recording medium, displaying an icon representing the presence of the associated moving image together with the still image so that the associated moving image can be easily reproduced by selecting the icon.

Japanese Patent Laid-Open No. 2008-053936 proposes a technique of determining whether the remaining capacity of an image recording medium has changed after the end of previous reproduction, if the remaining capacity has not changed, performing reproduction resume to reproduce images from one reproduced at the end of previous reproduction, and if the remaining capacity of the recording medium has changed, reproducing images from the latest one.

The apparatuses in Japanese Patent Laid-Open Nos. 2000-222417 and 2008-053936 do not consider a case in which a moving image different from a finally shot image or an image displayed at the end of the previous reproduction mode is displayed first at the start of the reproduction mode. Even if the user starts the reproduction mode in order to view a moving image associated with a still image, he needs to cumbersomely perform an image scrolling operation and an operation of displaying a moving image associated with a still image until a moving image he wants is displayed.

### SUMMARY OF THE INVENTION

The present invention has been made in consideration of the aforementioned problems, and implements initial display of an associated moving image when it is considered to be suitable to initially display a moving image associated with a still image at the start of the reproduction mode.

In order to solve the aforementioned problems, the present invention provides a display control apparatus comprising: a recording unit configured to record a still image and a moving image associated with the still image on a recording medium; a start image setting unit configured to set whether to set the associated moving image as a start image to be displayed first at a start of image reproduction; and a control unit configured to control to, when the start image setting unit has set the associated moving image as the start image, display the associated moving image from images recorded on the recording medium at the start of image reproduction, and control to, when the start image setting unit does not set the associated moving image as the start image, display an image based on another condition irrelevant to whether the image is the associated moving image, from images recorded on the recording medium at the start of image reproduction.

In order to solve the aforementioned problems, the present invention provides a display control apparatus comprising: an image capturing unit; a shooting mode setting unit configured to set one shooting mode from a plurality of shooting modes; a recording unit configured to record, on a recording medium, a still image shot when the shooting mode setting unit has set a specific shooting mode, and a moving image associated with the still image; and a control unit configured to control to, when the shooting mode setting unit has set the specific shooting mode and the shooting mode shifts to a reproduction mode, display the associated moving image at a start of the reproduction mode, and control to, when the shooting mode setting unit has set a shooting mode different from the specific shooting mode and the shooting mode shifts to the reproduction mode, display an image based on another condition irrelevant to whether the image is the associated moving image, from images recorded on the recording medium at the start of the reproduction mode.

In order to solve the aforementioned problems, the present invention provides a display control apparatus comprising: a recording unit configured to record a still image and a moving image associated with the still image on a recording medium; an operation mode setting unit configured to set one of a reproduction mode and another operation mode; and a control unit configured to control to, when the operation mode setting unit has set the reproduction mode upon changing a power supply from OFF to ON, display the associated moving image at a start of the reproduction mode, and control to, when the other operation mode is changed to the reproduction mode upon power-on, display an image based on another condition irrelevant to whether the image is the associated moving image, from images recorded on the recording medium.

In order to solve the aforementioned problems, the present invention provides a display control method of an apparatus having a recording unit configured to record a still image and a moving image associated with the still image on a recording medium, and a start image setting unit configured to set whether to set the associated moving image as a start image to be displayed first at a start of image reproduction, the method comprising: a control step of controlling to, when the start image setting unit has set the associated moving image as the start image, display the associated moving image from images recorded on the recording medium at the start of image reproduction, and controlling to, when the start image setting unit does not set the associated moving image as the start image, display an image based on another condition irrelevant to whether the image is the associated moving image, from images recorded on the recording medium at the start of image reproduction.

In order to solve the aforementioned problems, the present invention provides a display control method of an apparatus having an image capturing unit, a shooting mode setting unit configured to set one shooting mode from a plurality of shooting modes, and a recording unit configured to record, on a recording medium, a still image shot when the shooting mode setting unit has set a specific shooting mode, and a moving image associated with the still image, the method comprising: a control step of controlling to, when the shooting mode setting unit has set the specific shooting mode and the shooting mode shifts to a reproduction mode, display the associated moving image at a start of the reproduction mode, and controlling to, when the shooting mode setting unit has set a shooting mode different from the specific shooting mode and the shooting mode shifts to the reproduction mode, display an image based on another condition irrelevant to whether the image is the associated moving image, from images recorded on the recording medium at the start of the reproduction mode.

In order to solve the aforementioned problems, the present invention provides a display control method of an apparatus having a recording unit configured to record a still image and a moving image associated with the still image on a recording medium, and an operation mode setting unit configured to set one of a reproduction mode and another operation mode, the method comprising: a control step of controlling to, when the operation mode setting unit has set the reproduction mode upon changing a power supply from OFF to ON, display the associated moving image at a start of reproducing the image, and controlling to, when the other operation mode is changed to the reproduction mode upon power-on, display an image based on another condition irrelevant to whether the image is the associated moving image, from images recorded on the recording medium.

According to the present invention, when it is considered to be suitable to initially display a moving image associated with a still image at the start of the reproduction mode, the associated moving image can be displayed initially.

Further features of the present invention will become apparent from the following description of exemplary embodiments (with reference to the attached drawings).

### BRIEF DESCRIPTION OF THE DRAWINGS

FIG. 1 is a view showing the outer appearance of a digital camera according to an embodiment of the present invention;

FIG. 2 is a block diagram showing the digital camera according to the embodiment of the present invention;

FIG. 3 is a conceptual view showing the recording state of an image shot in a movie digest mode; and

FIGS. 4A and 4B are flowcharts showing reproduction mode processing by the digital camera according to the embodiment.

### DESCRIPTION OF THE EMBODIMENTS

An embodiment of the present invention will now be described in detail with reference to the accompanying drawings.

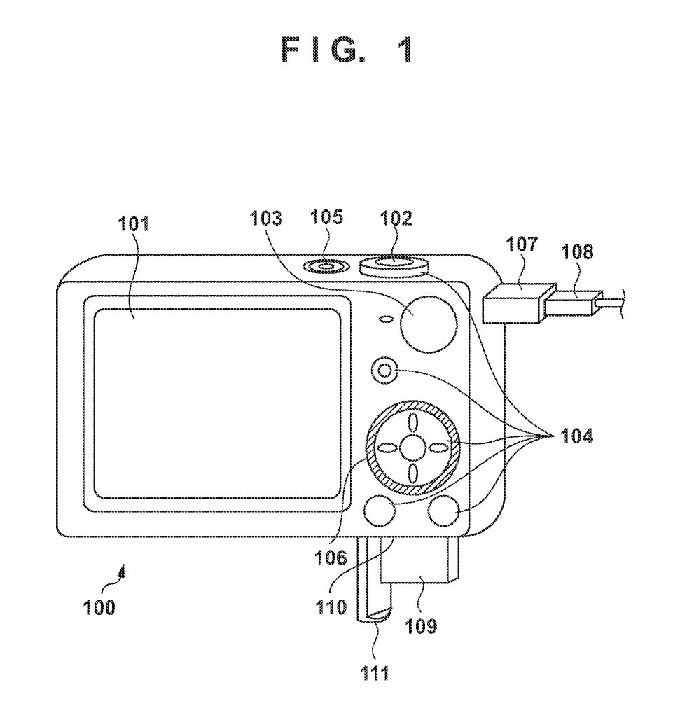

FIG. 1 shows the outer appearance of a digital camera 100 taken as an example of a display control apparatus of the present invention. In FIG. 1, a display unit 101 displays images and various information. A shutter button 102 is an operation unit for a shooting instruction. A mode switching button 103 is an operation unit for changing over among various modes. A connector 104 connects a connection cable 108 with a digital camera 100. Operation units 104 comprise operation members such as various switches, buttons and a touch panel operated in various ways by the user. A controller wheel 106 is a rotatable operation member included among the operation units 104. A power switch 105 switches between power on and power off. A recording medium 109 is a medium such as a memory card or hard disk. A recording medium slot 110 is for accommodating the recording medium 109. The recording medium 109 accommodated in the recording medium slot 110 makes it possible to communicate with the digital camera 100. A cover 111 covers the recording medium slot 110.

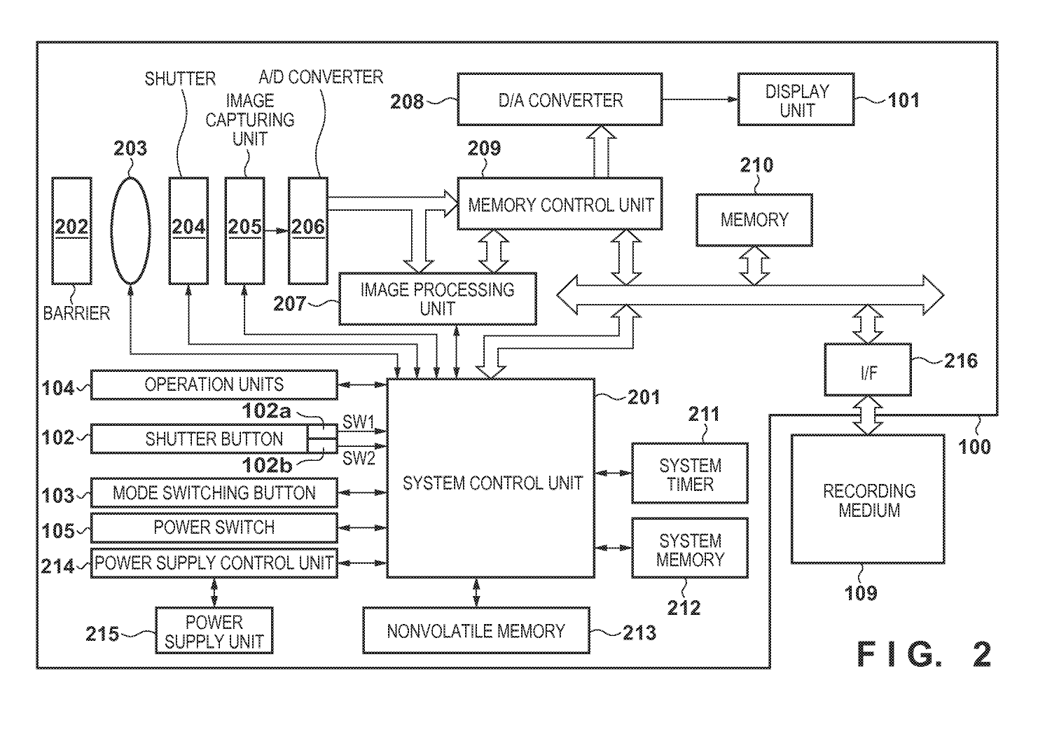

FIG. 2 is a block diagram exemplifying the configuration of the digital camera 100 according to this embodiment.

In FIG. 2, a photographing lens 203 includes a zoom lens and a focusing lens. A shutter 204 has a diaphragm function. An image capturing unit 205 is an image sensor, which is constituted by a CCD or CMOS or the like, for converting the optical image of a subject to an electric signal. An A/D converter 206 converts an analog signal to a digital signal. The A/D converter 204 is used to convert an analog signal, which is output from the image capturing unit 203, to a digital signal. A barrier 202 covers the image capturing system (which includes the photographing lens 203) of the digital camera 100, thereby preventing contamination of and damage to the image capturing system that includes the photographing lens 203, shutter 204 and image capturing unit 205.

An image processing unit 207 performs resizing processing, such as predetermined pixel interpolation and reduction, and color conversion processing, with respect to data from the A/D converter 206 or data from a memory control unit 209. Further, the image processing unit 207 performs predetermined calculation processing using the captured image data, and the system control unit 201 performs exposure control and distance measuring control based on the calculation results. Thus, AF (Automatic Focus) processing, AE (Automatic Exposure) processing, and EF (flash pre-emission) processing of TTL (Through the Lens) type are performed. Furthermore, the image processing unit 207 performs predetermined calculation processing using the captured image data, and AWB (Automatic White Balance) processing of TTL type is performed on the basis of the calculation results.

The data from the A/D converter 206 is directly written into a memory 2010 via both the image processing unit 207 and the memory control unit 209 or via the memory control unit 209. The memory 210 stores the image data obtained from the image capturing unit 205 and the A/D converter 206, and image display data to be displayed on the display unit 101. The memory 210 has a storage capacity that is sufficient for storing a predetermined number of still images as well as moving images and audio for a predetermined time period.

The memory 210 also functions as a memory for image display (video memory). A D/A converter 208 converts the image display data stored in the memory 210 into an analog signal and applies the display unit 101 with the analog signal. The image display data that was written into the memory 210 is displayed by the display unit 101 via the D/A converter 208. The display unit 101 performs, on a display device such as an LCD, display in accordance with the analog signal from the D/A converter 208. In this manner, the digital signals stored in the memory 210 are converted into analog signals, and the analog signals are successively transmitted to the display unit 101 so as to be displayed thereon, making it possible to realize an electronic view finder (EVF) functionality and to perform through image display (live view display).

A nonvolatile memory 213 is, for example, an EEPROM, which is electrically erasable and recordable. In the nonvolatile memory 213, constants and programs, for example, for operating the system control unit 201 are stored. In this context, “programs” may refer to programs for executing various flowcharts that will be described later.

The system control unit 201 is a calculation processing device for overall controlling the entire digital camera 100, and realizes, by executing the programs stored in the nonvolatile memory 213, the procedures of the flowchart that will be described later. The system memory 212 is, for example, a RAM and used also as a work memory where constants and variables for operating the system control unit 201, and the programs read out from the nonvolatile memory 213 are expanded. The system control unit 201 controls the memory 210, the D/A converter 208, the display unit 101, and the like, so as to perform display control.

A system timer 211 is a timer circuit for measuring time periods for various types of controls and the time of an integrated clock.

A mode switching button 103, a first shutter switch 102a, a second shutter switch 102b, and operation units 104 are operation members for inputting various types of instructions into the system control unit 201.

The mode switching button 103 switches the operation mode of the system control unit 201 to any of a still image recording mode, a moving image recording mode, and a reproduction mode. The still image recording mode includes an automatic shooting mode, an automatic scene determination mode, a manual mode, various types of scene modes in which different settings are configured for individual shooting scenes, a program AE mode, a custom mode, and the like. Using the mode switching button 103, the mode is directly switched to any of the plurality of modes included in the still image recording mode. Alternatively, it is also possible to switch, using the mode switching button 103, to the still image recording mode and then to switch, using another operation member, to any of the plurality of modes included in the still image shooting mode. Similarly, also the moving image shooting mode may include a plurality of modes.

While a shutter button 102 provided on the digital camera 100 is being operated, that is, pressed half-way (the shooting preparation instruction), the first shutter switch 102a is turned on and generates a first shutter switch signal SW1. Upon receiving the first shutter switch signal SW1, the system control unit 201 causes the image processing unit 207 to start the AF (Automatic Focus) processing, the AE (Automatic Exposure) processing, the AWB (Automatic White Balance) processing, the EF (flash pre-emission) processing and the like.

When the operation of the shutter button 102 is completed, that is, the shutter button 102 is pressed fully (the shooting instruction), the second shutter switch 102b is turned on and generates a second shutter switch signal SW2. Upon receiving the second shutter switch signal SW2, the system control unit 201 starts a series of shooting processing from reading out the signal from the image capturing unit 205 to writing of image data to the recording medium 109.

By selecting various functional icons displayed on the display unit 101, appropriate functions for each situation are assigned to the operation units 104, and the operation units 104 thus act as various function buttons. Examples of these function buttons include an end button, a back button, an image scrolling button, a jump button, a narrow-down button, an attribute change button. For example, a menu screen that enables various settings to be made is displayed on the display unit 101 by pressing a menu button. The user can make various settings intuitively by using the menu screen, which is displayed on the display unit 101, four-direction (up, down, left, right) buttons and a SET button.

The controller wheel 106, which is a rotatable operation member included among the operation units 104, is used together with the direction buttons as when a selection item is specified. When the controller wheel 106 is turned, an electrical pulse signal is generated in accordance with the amount of rotation, and the system control unit 201 controls each unit of the digital camera 100 based upon the pulse signal. The angle through which the controller wheel 106 has been turned and how many times it has been turned can be determined by the pulse signal. It should be noted that the controller wheel 106 can be any operation member so long as it is an operation member whose rotation can be detected. For example, it can be a dial operation member in which the controller wheel 106 per se is rotated to generate the pulse signal in accordance with a turning operation by the user. Further, it can be a device (a so-called touch wheel) that detects an operation such as the revolution of the user's finger on the controller wheel 106 without by controller wheel 106 itself being rotated.

A power supply control unit 214 is constituted by, for example, a battery detection circuit, a DC-DC converter, a switch circuit for changing over the block to be supplied with power, and detects a battery has been inserted or not, the type of the battery, and the residual capacity thereof. Further, the power supply control unit 119 controls the DC-DC converter in accordance with the detection results and an instruction of the system control unit 201, and supplies a necessary voltage for a necessary length of time to each of the units including the recording medium 109.

A power supply unit 215 comprises a primary battery such as an alkaline battery or a lithium battery, a secondary battery such as an NiCd battery, an NiMH battery, or an Li battery, or an AC adaptor. The recording medium interface (I/F) 216 is for interfacing with the recording medium 109 such as the memory card or hard disk. The recording medium 109 is a recording medium such as a memory card for recording shot images, and constituted by a semiconductor memory, a magnetic disk, or the like.

The digital camera 100 can be used by switching between at least a reproduction mode for reproducing an image and a shooting mode for shooting an image. The shooting mode includes an auto mode, manual mode, movie digest mode, and a plurality of scene-dependent shooting modes. The auto mode is a mode in which a program installed in the digital camera 100 automatically determines various parameters of the camera based on a measured exposure value. The manual mode is a mode in which the user can freely change various parameters of the camera. The movie digest mode will be described later. The scene-dependent shooting mode is a shooting mode implemented for each shooting scene by combining a shutter speed, f-number, flash emission, sensitivity setting, white balance (WB) setting, and the like which are suited to the shooting scene. The digital camera 100 includes the following scene-dependent shooting modes (1) to (10). However, the scene-dependent shooting modes are not limited to them.

(1) Water shooting mode (beach mode): a mode capable of shooting without darkening a person or the like even on the surface of the sea or a sandy beach where reflection of the sunbeam is strong.

(2) Night view shooting mode: a mode specialized in a night view scene to emit flash light to a person and record the background at a low shutter speed.

(3) Skyrocket shooting mode: a mode to vividly shoot a skyrocket at an optimum exposure.

(4) Underwater shooting mode: a mode to set a white balance optimum for underwater shooting and shoot at a blue-suppressed tone.

(5) Sunset shooting mode: a mode to emphasize a silhouette and red, and shoot.

(6) Portrait shooting mode: a mode specialized in person shooting to blur the background so that a person stands out.

(7) Sports shooting mode: a shooting mode to make settings specialized in shooting a quickly moving object.

(8) Snow shooting mode: a mode to shoot without darkening a person even in a snow scene and remaining blueness.

(9) Night & snap shooting mode: a mode suited to clear shooting of a night view and person without using a tripod

(10) Spotlight shooting mode: a mode to clearly shoot an object under a spotlight

The user can set one of the auto mode, manual mode, movie digest mode, and scene-dependent shooting modes by operating the mode switching button 103 and stopping it at a desirable position. More specifically, if the mode switching button 103 is operated to the position of the movie digest mode during the shooting mode, the shooting mode can quickly change to the movie digest mode. Note that switching in the shooting mode is not limited to this, and the movie digest mode may be set as one of the scene-dependent shooting modes. In this case, after the user operates the mode switching button 103 to the position of the scene-dependent shooting mode, he selects the movie digest mode from a scene-dependent shooting mode selection menu displayed on the display unit 101, thereby setting the movie digest mode. Information of the set mode is recorded in the nonvolatile memory 213.

The movie digest mode will be explained.

The digital camera 100 can shoot in the movie digest mode. The movie digest mode is a mode in which a moving image of a predetermined time (for example, 4 sec) before still image shooting is shot for each still image shot in a predetermined period, for example, for a day, and a moving image file in which the moving images are concatenated is recorded in association with the respective still images. In the movie digest mode, one or more still images are associated with one moving image. Also, in the movie digest mode, an associated moving image is generated as a digest moving image when a still image is shot for the first time in a predetermined period, and a moving image of a predetermined time before shooting is added to the generated moving image in every shooting of a still image without changing the file name. Note that additional writing is executed for the moving image file of one digest moving image unless the file capacity or total moving image time exceeds a value determined in advance as the capacity or time of one digest moving image. Hence, only one moving image file is basically recorded in the predetermined period.

When the operation mode of the digital camera 100 is switched to the movie digest mode by using the mode switching button 103, the system control unit 201 starts moving image shooting processing, and controls the memory control unit 209 to store a moving image obtained by shooting in the memory 210. The longest time of a moving image to be stored in the memory 210 is set to a predetermined time such as 4 sec. If the time of a moving image to be stored in the memory 210 exceeds the longest time, the system control unit 201 controls the memory control unit 209 to delete frames by the excess sequentially in chronological order of the shooting time.

If the system control unit 201 receives the signal SW2 serving as a shooting instruction, it stops writing of the moving image in the memory 210, and records the moving image stored in the memory 210 on the recording medium 109 as a digest moving image. In addition, the system control unit 201 shoots a still image, and records the still image file on the recording medium 109 in association with the digest moving image. After recording the still image file, the system control unit 201 restarts moving image shooting processing to record a moving image of the predetermined time in the memory 210.

When recording the digest moving image on the recording medium 109, the recording medium I/F 216 changes the digest moving image recording method on the recording medium 109 depending on whether the file of a digest moving image recorded in the same predetermined period has already existed in the recording medium 109. More specifically, when the file of a digest moving image recorded in the same predetermined period does not exist, the recording medium I/F 216 records the target digest moving image as a new file on the recording medium 109. An image ID indicating the reproduction order in viewing is assigned in recording. Assume that a number smaller than a still image file obtained by shooting based on the signal SW2 is added to the new digest moving image file. When a digest moving image recorded in the same predetermined period exists, the recording medium I/F 216 records the target digest moving image by concatenating it as a succession in the existing digest moving image file.

When still images are shot by a plurality of times in the movie digest mode, a moving image of the predetermined time before the first still image shooting is recorded first on the recording medium 109, and then still images associated with the moving image are recorded. In the second and subsequent still image shooting operations, the moving image of the predetermined time before still image shooting is added to the already recorded moving image. As the order of files managed in the recording medium 109, the moving image comes first, and then one or more still images associated with the moving image are recorded subsequently.

In the file of the digest moving image recorded on the recording medium 109, attribute information representing that the moving image file is a digest moving image is added to the header, or a thumbnail image file, management file, or the like associated with the moving image file. Also, an identifier representing the files of still images obtained by shooting which serves as a trigger to record a moving image portion included in the moving image file, and information (for example, time code, chapter number, and correspondence with a still image identifier) representing a moving image portion corresponding to these still images are recorded. The files of still images shot in the digest mode are associated with an identifier representing shooting in the movie digest mode, and an identifier (for example, file name, file number, or unique ID) representing the file of a digest moving image having a moving image portion recorded by shooting of the still images. These identifiers are recorded in, for example, the headers of the files of the still images. Information (for example, time code or chapter number) representing a moving image portion recorded by shooting of the still images out of the moving image associated with the still images is also recorded.

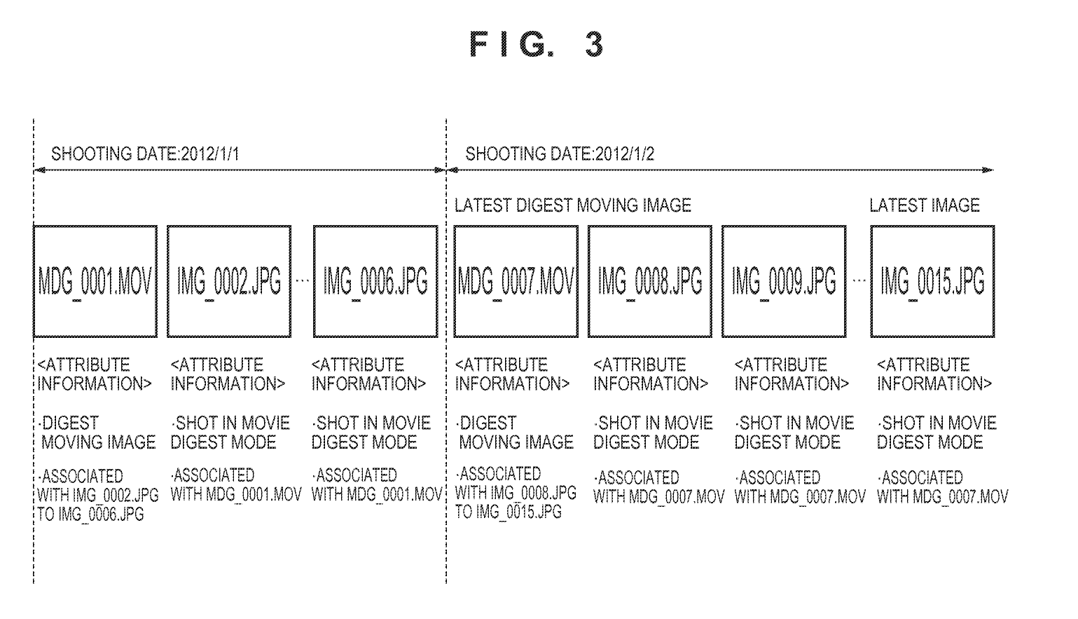

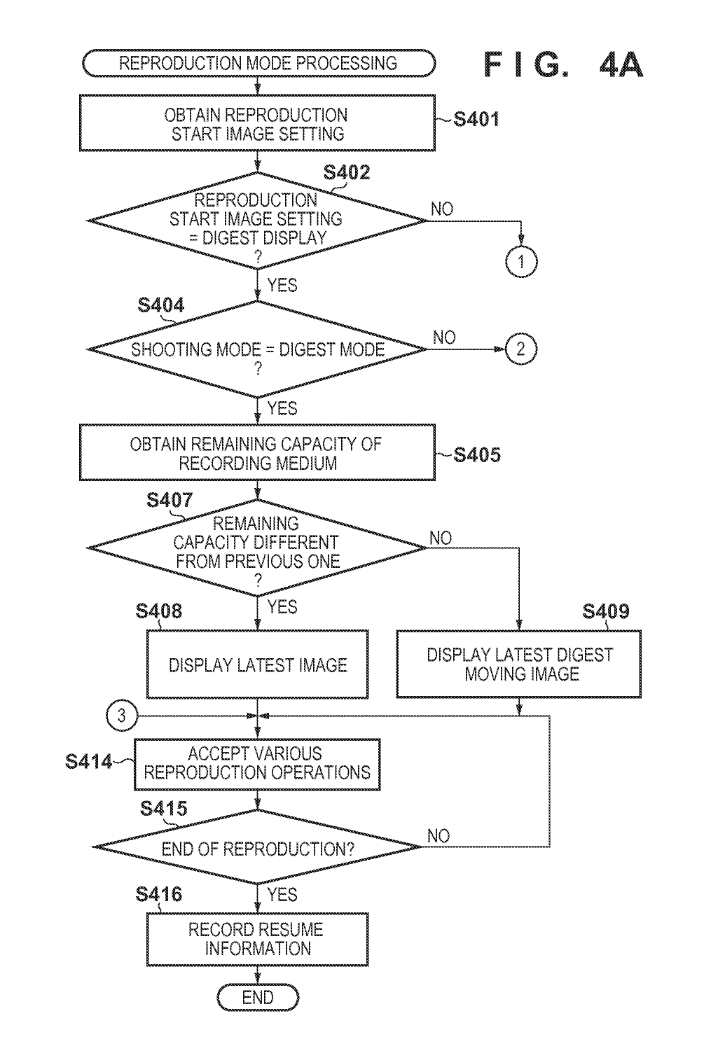

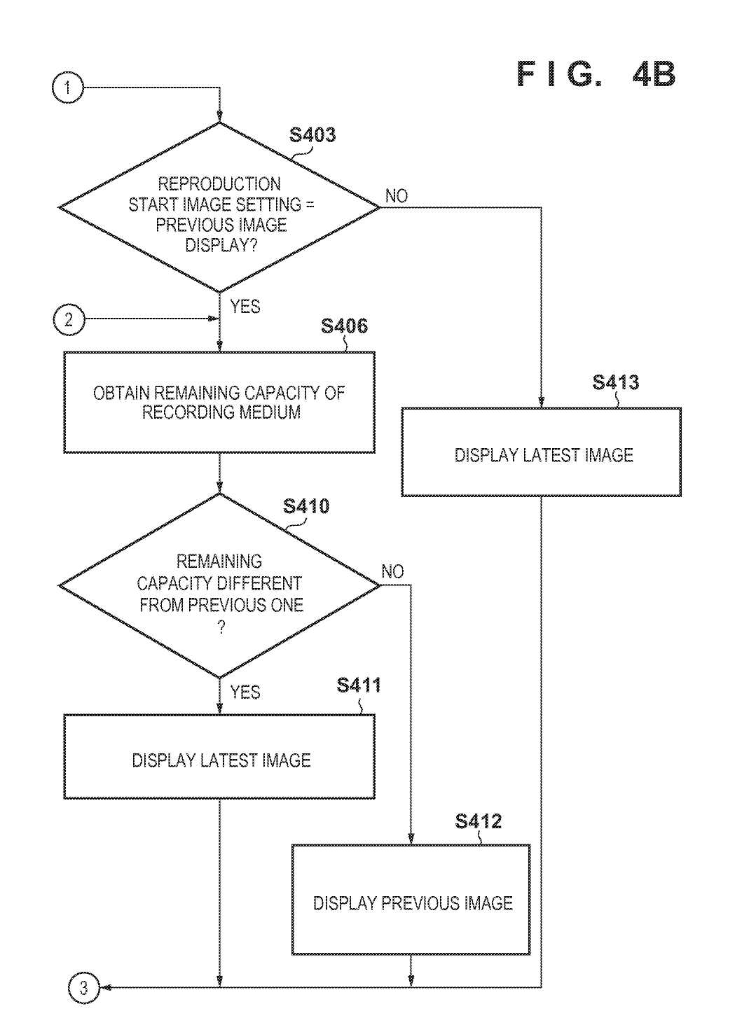

FIG. 3 exemplifies the file name, shooting date & time, and added attribute information of each image file which has been obtained by shooting in the movie digest mode and recorded on the recording medium 109. In FIG. 3, a file having an extension “.MOV” is a moving image file, and a file having an extension “.JPG” is a still image file. A four-digit figure before the extension corresponds to a file number. Although FIG. 3 shows an example in which only images shot in the movie digest mode are recorded, images shot in another shooting mode sometimes coexist, as a matter of course.

<Display Control Processing> Reproduction mode processing by the image capturing apparatus according to the embodiment will be described with reference to FIGS. 4A and 4B. The processing in FIGS. 4 A and 4B is implemented by expanding a program recorded in the nonvolatile memory 213 to the system memory 212, and executing it by the system control unit 201.

The processing in FIGS. 4A and 4B starts in response to activation of the reproduction mode. If the user presses a reproduction button included in the operation units 104 in the power-off state, the digital camera 100 is turned on and activated in the reproduction mode. Alternatively, when the user presses the reproduction button included in the operation units 104 while the digital camera 100 operates in an operation mode such as the shooting mode other than the reproduction mode, the digital camera 100 shifts to the reproduction mode to activate the reproduction mode.

Referring to FIGS. 4A and 4B, when the reproduction mode is activated, the system control unit 201 obtains the setting state of a reproduction start image setting by referring to the nonvolatile memory 213 in step S401. The reproduction start image setting is a setting made by the user about an image to be displayed first upon activation of the reproduction mode. The reproduction start image setting includes a previous image display setting of preferentially displaying an image displayed at the end of the previous reproduction mode (setting of performing so-called resume reproduction), a digest display setting of preferentially displaying the latest digest moving image, and a latest image display setting of always displaying the latest image upon activation of the reproduction mode. The user can select and set in advance one of the previous image display setting, digest display setting, and latest image display setting from the reproduction setting menu (the set information is recorded in the nonvolatile memory 213).

In step S402, the system control unit 201 determines whether the reproduction start image setting is the digest display setting. If the reproduction start image setting is the digest display setting, the process advances to step S404; if it is not the digest display setting, to step S403.

In step S404, the system control unit 201 determines, from the current position of the mode switching button 103 or setting information in the final shooting mode that has been recorded in the nonvolatile memory 213, whether the current setting of the shooting mode is the movie digest mode. If the current setting of the shooting mode is the movie digest mode, the process advances to step S405; if it is not the movie digest mode, to step S409.

In step S405, the system control unit 201 obtains the remaining capacity of the recording medium 109. In step S406, the system control unit 201 compares the remaining capacity obtained in step S405 with a remaining capacity before the end of the previous reproduction mode (that has been recorded in the nonvolatile memory 213 at the end of the previous reproduction mode), and determines whether the remaining capacity has changed after the end of the previous reproduction mode. If the remaining capacity has changed, the process advances to step S407 to display the latest image (IMG_{—}0015.JPG in the example of FIG. 3) recorded on the recording medium 109. The case in which the remaining capacity has changed is a case in which the same recording medium as that in previous reproduction is mounted and a new image is shot and recorded after the end of the previous reproduction mode, or a case in which a recording medium different from that in previous reproduction is mounted. If the remaining capacity has not changed, the process advances to step S408, and the system control unit 201 displays the first frame of the latest digest moving image (MDG_{—}0007.MOV in the example of FIG. 3) recorded on the recording medium 109, or displays the image of a frame at the previous stop. If the remaining capacity has not changed, it is considered that the same recording medium as that in previous reproduction is mounted and no new image is shot.

If the reproduction start image setting is not the digest display setting in step S402, the system control unit 201 determines in step S403 whether the reproduction start image setting is the previous image display setting. If the reproduction start image setting is the previous image display setting, the process advances to step S409; if it is not the previous image display setting, to step S413.

In steps S409 and S410, similar to steps S405 and S406, the system control unit 201 obtains the remaining capacity of the recording medium 109, and determines whether the remaining capacity of the recording medium 109 has changed from the end of the previous reproduction mode. If the remaining capacity has changed, the process advances to step S411, and the system control unit 201 displays the latest image recorded on the recording medium 109. If the remaining capacity has not changed, the process advances to step S412, and the system control unit 201 displays an image displayed at the end of the previous reproduction mode by referring to resume information recorded in the nonvolatile memory 213.

If the reproduction start image setting is not the previous image display setting in step S403, the process advances to step S413, and the system control unit 201 displays the latest image recorded on the recording medium 109.

By the above processing, the first image after shift to the reproduction mode is displayed.

In step S414, various operations acceptable in the reproduction mode are accepted, and various processes corresponding to the accepted operations are performed. The acceptable operations and corresponding processes are as follows: reproduction, rewind, fast forward, and slow reproduction instructions for a displayed moving image, and corresponding processes (when a digest moving image is displayed, moving image reproduction can start); image backward and image forward in accordance with operations to left and right buttons (left and right keys) included in the operation units 104 (an image to be displayed is switched to an image having a preceding or next image file number); file deletion of a displayed image, protection, and transfer to an external device; image processing instructions such as resizing and trimming; a slide show to automatically switch and display a plurality of images; and display of a reproduction setting menu screen in response to pressing of a menu button included in the operation units 104, and acceptance of various operations on the menu screen (accordingly, the above-described reproduction start image setting can be performed).

In step S415, the system control unit 201 determines whether there is a trigger to end the reproduction mode. The trigger to end the reproduction mode includes an operation to turn off the power supply, and an operation to change to another operation mode such as the shooting mode. If there is no trigger to end the reproduction mode, the process returns to step S414; if there is the trigger, shifts to step S416.

In step S416, the system control unit 201 records resume information in the nonvolatile memory 213 to enable the next resume reproduction. The resume information records the file identifier (for example, file number, file name, or file ID) of an immediately preceding displayed image, and the remaining capacity of the recording medium 109 at this time. After the end of the processing in step S416, the reproduction mode processing ends.

When the reproduction start image setting is the digest display setting, whether the remaining capacity of the recording medium 109 has changed is determined in steps S405 and S406. If the remaining capacity has not changed, the process advances to step S408 to display a digest moving image. If the remaining capacity of the recording medium 109 has changed from the end of previous reproduction, and the recording medium is the same as that at the end of previous reproduction, this means that shooting has been performed again in the shooting mode after the end of previous reproduction. In this case, even if the reproduction mode is activated, the reproduction mode is highly likely to be activated not to enjoy a digest moving image and look back on the day slowly, but to check an image which has been just shot in the course of shooting. In such a case, not a digest moving image which takes the moving image reproduction time for check, but the latest image which has been just shot is displayed so that the user can confirm the finish of immediately preceding shooting, thereby improving user friendliness.

In step S408, the latest digest moving image is displayed regardless of whether the latest image recorded on the recording medium 109 is a still image shot in the movie digest mode. With this setting, even if the latest image is not a still image shot in the movie digest mode, the latest digest moving image can be reproduced first upon shift to the reproduction mode.

According to the above-described embodiment, the latest image, resume image, or digest moving image can be adaptively displayed in accordance with the contents of the reproduction start image setting by the user or a change of the remaining capacity of the recording medium (that is, whether a new image has been shot) upon activation of the reproduction mode. More specifically, when the power supply is OFF and is turned on in the reproduction mode, or when the digital camera 100 is switched from the shooting mode to the reproduction mode, if the shooting mode is the movie digest mode and the remaining capacity of the recording medium has not changed from a state before activating the reproduction mode (that is, no new image has been shot), the digest moving image of the latest image shot in the shooting mode is reproduced.

<Modification> In FIGS. 4A and 4B, the processes in steps S405 to S407 are not performed, and if YES in step S404, the process may advance to step S408 to display the latest digest moving image regardless of whether shooting has been performed again after the end of previous reproduction. In this case, when the reproduction start image setting is the digest display setting, even immediately after a new image has been shot in the movie digest mode, a digest moving image can be displayed to confirm a moving image to which a video corresponding to the newly shot still image is added. Further, if YES in step S402, the process may advance to step S408 without the determination in step S404. That is, when the reproduction start image setting indicates a digest moving image, the latest digest moving image may be displayed regardless of the remaining capacity of the recording medium.

When the digital camera 100 shifts from the shooting mode directly to the reproduction mode, the reproduction mode is highly likely to have been activated in order to check an image which has been just shot during a series of shooting operations. To the contrary, when the digital camera 100 shifts from the power-off state to the reproduction mode, the reproduction mode is highly likely to have been activated in order not to check the state of an image which has been just shot, but to enjoy images slowly. It is therefore possible to insert, before step S405, a step of determining whether the power supply is OFF immediately before activation in the reproduction mode, and determine the remaining capacity in accordance with the state. More specifically, if the power supply is OFF immediately before activation in the reproduction mode, the process directly advances to step S408 to display the latest digest moving image. If the power supply is not OFF immediately before activation in the reproduction mode (the digital camera 100 is switched from the shooting mode to the reproduction mode in the power-on state), the processes in steps S405 and S406 may be performed, and only when the remaining capacity has not changed from the previous one, the process may advance to step S408 to display a digest moving image. Alternatively, if the power supply is not OFF immediately before activation in the reproduction mode, the process may directly advance to step S407 to display the latest image (regardless of the remaining capacity of the recording medium) or display a resume image.

When the power supply is changed from OFF to ON in the reproduction mode, the latest digest moving image may be displayed regardless of at least one of the reproduction start image setting, the current shooting mode, and the remaining capacity of the recording medium. In this case, upon power-on in the reproduction mode when the reproduction mode is highly likely to have been activated in order to enjoy images slowly, the user can easily reproduce a digest moving image upon power-on and look back on the day.

In step S408, it may be determined from attribute information whether the latest still image recorded on the recording medium 109 is an image shot in the movie digest mode, if it is an image shot in the movie digest mode, the latest digest moving image may be displayed, and if NO, the latest still image may be displayed or an image displayed at the end of the previous reproduction mode may be displayed. In this case, when the latest image has been shot in the movie digest mode, the user can easily check a digest moving image to which a moving image has been added in shooting the latest image. In contrast, if the latest shooting has not been performed in the movie digest mode, it can be prevented to display a digest moving image unassociated with the latest image.

In FIGS. 4A and 4B, the process may start from step S404 without performing the processes in steps S401 to S403. More specifically, it may be determined regardless of the reproduction start image setting whether the current shooting mode is the movie digest mode, and when it is the movie digest mode, the latest digest moving image may be preferentially displayed. Also in this case, if the current shooting mode is the movie digest mode, the latest digest moving image may be displayed regardless of the remaining capacity of the recording medium (that is, if YES in step S404, the process directly advances to step S408). Only when the power supply is changed from OFF to ON in the reproduction mode, if the current shooting mode is the movie digest mode regardless of the reproduction start image setting, the latest digest moving image may be preferentially displayed (the process may start from step S404). If the power supply is ON and another operation mode is switched to the reproduction mode, even the processes in steps S401 to S403 may be performed to execute processing corresponding to the reproduction start image setting, or the latest image or resume image may be displayed.

It is also possible to insert, before step S408, a step of determining whether the latest digest moving image is a digest moving image (digest moving image to be added) to be added when a still image is shot in the current state. Whether the latest digest moving image is a digest moving image to be added can be determined from whether the latest digest moving image is a digest moving image of the same date as the current date & time (whether it falls within a predetermined period including the current date & time). If the latest digest moving image is a digest moving image to be added, the latest digest moving image may be displayed in step S408; if NO, the latest image may be displayed or an image displayed at the end of the previous reproduction mode may be displayed. For example, when the predetermined period is one day and the shooting date of the latest digest moving image is the same date as today counted by the system timer 211 (belongs to the same predetermined period), it can be determined that the latest digest moving image is a digest moving image to be added. With this setting, even if a digest moving image shot in a predetermined period (for example, today) including the present time does not exist, it can be prevented to display a digest moving image outside the predetermined period that is irrelevant to the present time.

It is also possible to display the latest digest moving image if the latest digest moving image exists a predetermined time (for example, three days before today) before the predetermined period (for example, today) including the present time, and if NO, display the latest still image or an image displayed at the end of the previous reproduction mode. It can therefore be prevented to display an old digest moving image irrelevant to the purpose of current reproduction by the user. When there is a digest moving image regarding a recent event, the user can easily reproduce the digest moving image and look back on the recent event. For example, when the user activates the digital camera 100 in the reproduction mode for the first time today, he can display a digest moving image first and look back on his yesterday's trip. Also, when the user activates the digital camera 100 in the reproduction mode for the first time today and has not shot in the movie digest mode in recent days, the latest image or resume image is displayed.

Note that a single item of hardware may control the system control unit 201, or the entire apparatus may be controlled by a plurality of items of hardware sharing processing.

Although the present invention has been elaborated above based on suitable embodiments thereof, the present invention is by no means limited to these specific embodiments and includes various modifications without departing from the concept of the present invention. The above embodiments are merely illustrative embodiments of the present invention, and may be combined where appropriate.

Although the above embodiments have described an example in which the present invention is applied to a digital camera, the present invention is not limited to this example. The present invention is applicable to, for example, an apparatus by which a moving image associated with a still image can be displayed. More specifically, the present invention is applicable to personal computers, PDAs, a mobile telephone terminal, a mobile image viewer, a printer having a display, a digital photo frame, a game console, an electronic book reader, and the like.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-166339, filed Jul. 26, 2012, which is hereby incorporated by reference herein in its entirety.

What is claimed is:

1. A display control apparatus comprising:
a recording unit configured to record a still image and a moving image associated with the still image on a recording medium;
a start image setting unit configured to set whether to set the associated moving image as a start image to be displayed first at a start of image reproduction; and
a control unit configured to control to, when the start image setting unit has set the associated moving image as the start image, display the associated moving image from images recorded on the recording medium at the start of image reproduction, and control to, when the start image setting unit does not set the associated moving image as the start image, display an image based on another condition irrelevant to whether the image is the associated moving image, from images recorded on the recording medium at the start of image reproduction.

2. The apparatus according to claim 1, wherein
the start image setting unit can set, as the start image, one of the associated moving image, a latest image recorded on the recording medium, and a resume image serving as an image finally displayed at an end of previous reproduction, and
when the start image setting unit has set the latest image as the start image, the control unit controls to display the latest image at the start of image reproduction, and when the start image setting unit has set the resume image as the start image, display the resume image at the start of image reproduction.

3. The apparatus according to claim 1, further comprising:
an image capturing unit; and
a shooting mode setting unit configured to set one shooting mode from a plurality of shooting modes,
wherein when the shooting mode setting unit has set a specific shooting mode and a still image is shot, the recording unit records the shot still image and a moving image associated with the still image on the recording medium, and
at the start of image reproduction, when the start image setting unit has set the associated moving image as the start image and the shooting mode setting unit has set the specific shooting mode, the control unit controls to display the associated moving image, and when the start image setting unit has set the associated moving image as the start image and the shooting mode setting unit has not set the specific shooting mode, display the image based on the other condition.

4. The apparatus according to claim 1, further comprising an operation mode setting unit configured to set one of a reproduction mode and another operation mode,
wherein at a start of image reproduction in the reproduction mode, when the start image setting unit has set the associated moving image as the start image and a power supply is changed from OFF to ON in the reproduction mode, the control unit controls to display the associated moving image, and when the start image setting unit has set the associated moving image as the start image and the other operation mode is switched to the reproduction mode upon power-on, display the image based on the other condition.

5. The apparatus according to claim 1, further comprising:
an image capturing unit;
a shooting mode setting unit configured to set one shooting mode from a plurality of shooting modes; and
an operation mode setting unit configured to set one of a reproduction mode and another operation mode,
wherein at a start of image reproduction in the reproduction mode, when the start image setting unit has set the associated moving image as the start image, the shooting mode setting unit has set the specific shooting mode, and a power supply is changed from OFF to ON in the reproduction mode, the control unit controls to display the associated moving image, and even if the start image setting unit has set the associated moving image as the start image, when the shooting mode setting unit has not set the specific shooting mode, and when the other operation mode is switched to the reproduction mode upon power-on, display the image based on the other condition.

6. The apparatus according to claim 1, further comprising a determination unit configured to determine whether a remaining capacity of the recording medium at the start of image reproduction is different from a remaining capacity of the recording medium at an end of previous reproduction,
wherein when the determination unit determines that the remaining capacities are different, the control unit controls to display a latest image recorded on the recording medium at the start of image reproduction regardless of a setting of the start image setting unit.

7. The apparatus according to claim 1, wherein the image based on the other condition is a latest image recorded on the recording medium, or a resume image serving as an image finally displayed at an end of previous reproduction.

8. The apparatus according to claim 1, wherein the associated moving image includes a moving image of a moving image file including a moving image recorded in accordance with an instruction to shoot the still image.

9. The apparatus according to claim 1, wherein the associated moving image includes a moving image associated with a plurality of still images, and is recorded with a file number preceding file numbers of the associated still images.

10. The apparatus according to claim 1, wherein the associated moving image includes a moving image obtained by concatenating moving images shot upon receiving instructions to shoot respective still images, which have been shot in a predetermined period.

11. The apparatus according to claim 1, wherein at the start of image reproduction, when the associated moving image recorded in a predetermined period including a time point of the start does not exist, the control unit controls to display the image based on the other condition.

12. A display control apparatus comprising:
an image capturing unit;
a shooting mode setting unit configured to set one shooting mode from a plurality of shooting modes;
a recording unit configured to record, on a recording medium, a still image shot when the shooting mode setting unit has set a specific shooting mode, and a moving image associated with the still image; and
a control unit configured to control to, when the shooting mode setting unit has set the specific shooting mode and the shooting mode shifts to a reproduction mode, display the associated moving image at a start of the reproduction mode, and control to, when the shooting mode setting unit has set a shooting mode different from the specific shooting mode and the shooting mode shifts to the reproduction mode, display an image based on another condition irrelevant to whether the image is the associated moving image, from images recorded on the recording medium at the start of the reproduction mode.

13. The apparatus according to claim 12, further comprising an operation mode setting unit configured to set one of the reproduction mode and another operation mode,
wherein at a start of image reproduction in the reproduction mode, when the shooting mode setting unit has set the specific shooting mode and a power supply is changed from OFF to ON in the reproduction mode, the control unit controls to display the associated moving image, and when the shooting mode setting unit has set the specific shooting mode and the other operation mode is switched to the reproduction mode upon power-on, display the image based on the other condition.

14. The apparatus according to claim 12, further comprising a determination unit configured to determine whether a remaining capacity of the recording medium at the start of image reproduction is different from a remaining capacity of the recording medium at an end of previous reproduction,
wherein when the determination unit determines that the remaining capacities are different, the control unit controls to display a latest image recorded on the recording medium at the start of image reproduction regardless of a setting of the shooting mode setting unit.

15. The apparatus according to claim 12, wherein the image based on the other condition is a latest image recorded on the recording medium, or a resume image serving as an image finally displayed at an end of previous reproduction.

16. The apparatus according to claim 12, wherein the associated moving image includes a moving image of a moving image file including a moving image recorded in accordance with an instruction to shoot the still image.

17. The apparatus according to claim 12, wherein the associated moving image includes a moving image associated with a plurality of still images, and is recorded with a file number preceding file numbers of the associated still images.

18. The apparatus according to claim 12, wherein the associated moving image includes a moving image obtained by concatenating moving images shot upon receiving instructions to shoot respective still images, which have been shot in a predetermined period.

19. The apparatus according to claim 12, wherein at the start of image reproduction, when the associated moving image recorded in a predetermined period including a time point of the start does not exist, the control unit controls to display the image based on the other condition.

20. A display control apparatus comprising:
a recording unit configured to record a still image and a moving image associated with the still image on a recording medium;
an operation mode setting unit configured to set one of a reproduction mode and another operation mode; and
a control unit configured to control to, when the operation mode setting unit has set the reproduction mode upon changing a power supply from OFF to ON, display the associated moving image at a start of the reproduction mode, and control to, when the other operation mode is changed to the reproduction mode upon power-on, display an image based on another condition irrelevant to whether the image is the associated moving image, from images recorded on the recording medium.

21. The apparatus according to claim 20, further comprising a determination unit configured to determine whether a remaining capacity of the recording medium at the start of image reproduction is different from a remaining capacity of the recording medium at an end of previous reproduction,
wherein the control unit controls to display a latest image recorded on the recording medium at the start of image reproduction regardless of a state from which the reproduction mode has started.

22. The apparatus according to claim 20, wherein the image based on the other condition is a latest image recorded on the recording medium, or a resume image serving as an image finally displayed at an end of previous reproduction.

23. The apparatus according to claim 20, wherein the associated moving image includes a moving image of a moving image file including a moving image recorded in accordance with an instruction to shoot the still image.

24. The apparatus according to claim 20, wherein the associated moving image includes a moving image associated with a plurality of still images, and is recorded with a file number preceding file numbers of the associated still images.

25. The apparatus according to claim 20, wherein the associated moving image includes a moving image obtained by concatenating moving images shot upon receiving instructions to shoot respective still images, which have been shot in a predetermined period.

26. The apparatus according to claim 20, wherein at the start of image reproduction, when the associated moving image recorded in a predetermined period including a time point of the start does not exist, the control unit controls to display the image based on the other condition.

27. A display control method of an apparatus having a recording unit configured to record a still image and a moving image associated with the still image on a recording medium, and a start image setting unit configured to set whether to set the associated moving image as a start image to be displayed first at a start of image reproduction, the method comprising:
a control step of controlling to, when the start image setting unit has set the associated moving image as the start image, display the associated moving image from images recorded on the recording medium at the start of image reproduction, and controlling to, when the start image setting unit does not set the associated moving image as the start image, display an image based on another condition irrelevant to whether the image is the associated moving image, from images recorded on the recording medium at the start of image reproduction.

28. A display control method of an apparatus having an image capturing unit, a shooting mode setting unit configured to set one shooting mode from a plurality of shooting modes, and a recording unit configured to record, on a recording medium, a still image shot when the shooting mode setting unit has set a specific shooting mode, and a moving image associated with the still image, the method comprising:
a control step of controlling to, when the shooting mode setting unit has set the specific shooting mode and the shooting mode shifts to a reproduction mode, display the associated moving image at a start of the reproduction mode, and controlling to, when the shooting mode setting unit has set a shooting mode different from the specific shooting mode and the shooting mode shifts to the reproduction mode, display an image based on another condition irrelevant to whether the image is the associated moving image, from images recorded on the recording medium at the start of the reproduction mode.

29. A display control method of an apparatus having a recording unit configured to record a still image and a moving image associated with the still image on a recording medium, and an operation mode setting unit configured to set one of a reproduction mode and another operation mode, the method comprising:
a control step of controlling to, when the operation mode setting unit has set the reproduction mode upon changing a power supply from OFF to ON, display the associated moving image at a start of reproducing the image, and controlling to, when the other operation mode is changed to the reproduction mode upon power-on, display an image based on another condition irrelevant to whether the image is the associated moving image, from images recorded on the recording medium.

30. A non-transitory computer-readable storage medium storing a program for causing a computer to execute the control method according to claim 27.

31. A non-transitory computer-readable storage medium storing a program for causing a computer to execute the control method according to claim 28.

32. A non-transitory computer-readable storage medium storing a program for causing a computer to execute the control method according to claim 29.
